(19) United States
(12) Patent Application Publication
(10) Pub. No.: US 2004/0244562 A1
(43) Pub. Date: Dec. 9, 2004

(54) Ocarinas with chamber extensions that distance toneholes from the fipple window

(76) Inventor: Karl P. Ahrens, Bloomfield, CT (US)

Correspondence Address: MCCORMICK, PAULDING & HUBER LLP, CITY PLACE II, 185 ASYLUM STREET, HARTFORD, CT, 06103, US

(21) Appl. No.: 10/820,326

(22) Filed: Apr. 8, 2004

Related U.S. Application Data
(60) Provisional application No. 60/461,485, filed on Apr. 9, 2003.

(51) Int. Cl. G10D 7/00; G10D 7/02

(52) U.S. Cl. 84/380 R

(57) ABSTRACT

In one embodiment, an ocarina comprises a sound chamber having a plurality of apertures that facilitate airflow through the sound chamber to produce a tone and an extension in the form of a recess that extends the sound chamber. The recess is disposed at an inner surface of the sound chamber such that at least one tonehole is in register with the recess. In another embodiment, an ocarina has a body in which is disposed a plurality of apertures. The apertures, namely, a windway, a fipple window, and toneholes, facilitate airflow through the body. The body is defined by at least one wall, an adjacent surface (e.g., a bottom), and a cover. The wall, the surface, and the cover cooperate to form a sound chamber. An inner surface of the wall of the sound chamber includes an extension formed by a recess that is positioned adjacent to the cover. At least one of the toneholes is in register with the recess.

### CROSS REFERENCE TO RELATED PATENT APPLICATION

The present application claims the benefits of U.S. Provisional Patent Application Ser. No. 60/461,485, filed Apr. 9, 2003, entitled “Ocarinas With Chamber Extensions That Distance Toneholes From The Fipple Window,” which is incorporated herein by reference in its entirety.

### FIELD OF THE PRESENT INVENTION

The present invention relates generally to musical wind instruments and is more specifically directed to ocarinas having chamber extensions that distance toneholes of an ocarina from a fipple window of the ocarina.

### BACKGROUND OF THE PRESENT INVENTION

An edgetone wind instrument relies on the impingement of air on an edge as the air passes into a sound chamber to cause the air to oscillate to produce an audible tone. One such wind instrument is a whistle flute or fipple flute, which employs a whistle-type mouthpiece and is among the most ancient of all musical instruments. In this family are the recorder (also known as the fipple flute or English flute), the flageolet, and the ocarina (also known as the globular flute or the vessel flute). The ocarina dates back to antiquity and is reported to be of South American or Central American descent, though there are indications of its use in other parts of the ancient world.

Most types of wind instruments employ an open-ended tubular- or conical-shaped cavity to produce sound, whereas ocarinas utilize an enclosed sound chamber or cavity. Ocarinas have at least one windway that directs an air stream across a fipple window to impinge upon a fipple edge, at least one sound chamber, and a plurality of toneholes that penetrate the enclosed chamber and are used to control the pitch sounded by the instrument.

The volume of air contained within the sound chamber of an ocarina corresponds to the pitch of the notes sounded by that ocarina. All other things being equal, an ocarina with a larger sound chamber will produce notes of a lower pitch than will an ocarina with a smaller sound chamber. However, in the case of two ocarinas whose sound chambers enclose the same volume of air, an ocarina with a shorter, deeper sound chamber will often produce a stronger, clearer tone on certain notes than will an ocarina having a longer shallower sound chamber. Unfortunately, a shorter, deeper-chambered ocarina might not provide sufficient space to accommodate the desired number of toneholes (finger holes) or sufficient space between the respective toneholes. Furthermore, the toneholes may need to be placed closer to the fipple window than would be necessary if the sound chamber were longer and shallower.

Ocarinas—particularly those with a relatively wide tonal range and a relatively loud sound—can potentially produce airy, squeaky high notes if the toneholes are placed too close to the fipple window. These potentially squeaky high notes make playing such an ocarina more difficult (especially for a novice) and less expressive because players must blow with rather precise air stream speed to avoid squeaking. Moreover, squeaking is often exacerbated by the presence of condensed moisture in the ocarina windway, such moisture being a natural result of playing the instrument.

What is needed is an ocarina having a sufficiently deep sound chamber capable of producing a relatively strong, clear tone, sufficient space to allow the desired number of toneholes and/or sufficient space between each respective tonehole to allow the ocarina to be played comfortably, and sufficient space separating the toneholes from the fipple window to avoid squeaky high notes.

### SUMMARY OF THE PRESENT INVENTION

In one embodiment, the present invention is directed to an ocarina comprising a sound chamber having a plurality of apertures and an extension in the form of a recess that extends the sound chamber as well as the overall length of the instrument. The apertures facilitate airflow through the sound chamber to produce a tone. The recess is disposed at an inner surface of the sound chamber such that at least one tonehole is in register with the recess.

In another embodiment of the present invention, an ocarina has a body in which is disposed a plurality of apertures. The apertures, namely, a windway, a fipple window, and toneholes, facilitate airflow through the body to produce the desired musical notes. The body is defined by at least one wall, an adjacent surface (e.g., a bottom), and a cover. The wall, the surface, and the cover cooperate to form a sound chamber. An inner surface of the wall of the sound chamber includes an extension formed by a recess that is positioned adjacent to the cover. At least one of the toneholes, which is preferably drilled, bored, or otherwise formed in the cover, is in register with the recess.

In any embodiment of the ocarina, the sound chamber extension lengthens the ocarina, thereby allowing additional space for toneholes while maintaining a shorter, deeper sound chamber for better sound quality. In addition, the chamber extension allows the toneholes to be placed farther from the fipple window of the ocarina, thereby reducing the chances of producing a squeaking sound when playing high notes. Although the length of the ocarina is increased, the extensions add relatively little volume to the overall volume of air contained in the sound chamber.

### BRIEF DESCRIPTION OF THE DRAWINGS

FIG. 1 is a perspective view of an ocarina.

FIG. 2 is an exploded perspective view of an ocarina having a recess that forms an extension of the sound chamber.

FIG. 3 is an exploded perspective view of an ocarina having two recesses that form extensions of the sound chamber.

FIG. 4 is a cross-sectional representation showing the windway/fipple edge arrangement and the extension/tonehole arrangement of an ocarina.

### DETAILED DESCRIPTION OF THE PREFERRED EMBODIMENT

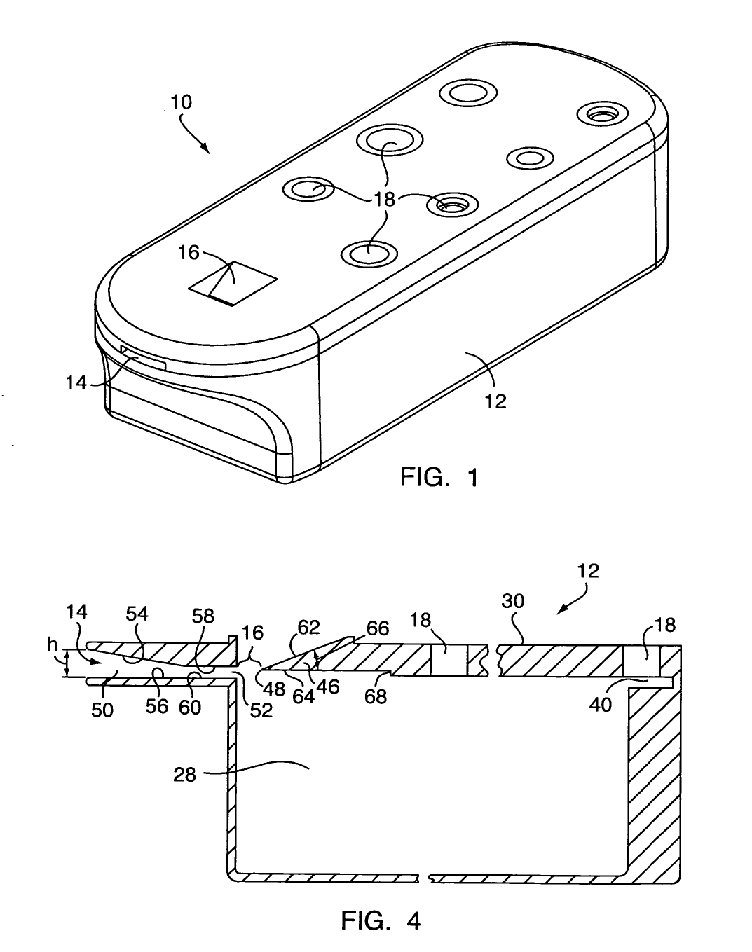

Referring to FIG. 1, an ocarina is shown generally at 10. The ocarina 10 includes an instrument body 12 perforated with a plurality of apertures. The apertures facilitate airflow communication through at least one sound chamber and at least one recess that forms an extension that extends from the sound chamber. The sound chamber and the recess(es) are defined by inner surfaces of walls of the instrument body 12. The apertures include at least one windway 14 through which air is blown into the ocarina 10, at least one fipple window 16 from which at least a portion of the air is expelled, and a plurality of toneholes 18. At least one of the toneholes 18 is in register with a recess.

In the operation of the ocarina 10, air is propelled through the windway 14 and impinges on a fipple edge, thereby causing the air in the sound chamber to oscillate, which produces sound waves having a frequency and an amplitude. When the toneholes 18 are selectively obstructed during the forcing of air through the windway 14, the frequency at which the air in the sound chamber oscillates is varied, thereby producing tones of varying pitches. The obstruction of the toneholes 18 is effected by a person placing their fingers over the toneholes 18 to fully or partially close the openings. Generally, uncovering more toneholes 18 causes the air in the sound chamber to oscillate more rapidly, which raises the pitch sounded by the ocarina 10. The ocarina 10 may be fabricated of wood, metal, clay, plastic, or any moldable or machinable material, as well as combinations of the foregoing materials.

Referring now to FIG. 2, the instrument body 12 of the ocarina 10 includes at least one wall 22 and a cooperating adjacent surface 26 arranged to form at least a portion of the sound chamber. The instrument body 12 further includes a cover 30 that cooperates with the wall 22 to close the sound chamber and the instrument body 12.

The toneholes 18 are preferably molded into the cover 30 but may be drilled, bored, or otherwise formed therein. Generally, two rows of toneholes 18 are disposed in the cover 30, the toneholes 18 of each row being arranged to allow sufficient space therebetween to accommodate movement of the fingers of the person playing the ocarina 10. In general, the diameters and depths of the various toneholes 18, rather than their precise location, determine their resulting pitch. At least one lower tonehole 32 is preferably disposed in the surface 26, such lower tonehole 32 being selectively obstructable by a thumb of the person playing the ocarina 10. The smaller toneholes 18 in the cover 30 and the smaller lower toneholes 32 in the surface 26 may be counterbored or countersunk to allow the person playing the ocarina 10 to more easily locate the toneholes 18 or the lower toneholes 32.

A recess, shown at 40, extends from the sound chamber into the defining wall of the chamber. The recess 40 is positioned at the end of the sound chamber that is opposite the end at which the fipple window 16 is positioned in an assembled ocarina 10. A width of the recess 40 is preferably narrower than a width of the sound chamber. Furthermore, a depth of the recess 40 may be less than a depth of the sound chamber. Preferably, the distance that the recess 40 extends into the wall 22 of the body 12 allows at least one tonehole 18 (typically the tonehole(s) 18 that are coverable by the third and/or fourth fingers of the hand) to register with the recess 40. Irrespective of the width and depth of the recess 40 and the distance that it extends into the wall 22, the total volume of the recess 40 adds relatively little volume to the overall volume of air contained in the sound chamber.

Referring now to FIG. 3, an ocarina having two recesses that form extensions is shown generally at 110. The ocarina 110 is configured to be substantially similar to the ocarina as shown in FIGS. 1 and 2, but includes a first recess 140 and a second recess 141. By incorporating both the first recess 140 and the second recess 141 into a wall 122 of a body 112 of the ocarina 110, two rows of toneholes 118 can be extended. The ocarina 110 may include at least one lower tonehole 132.

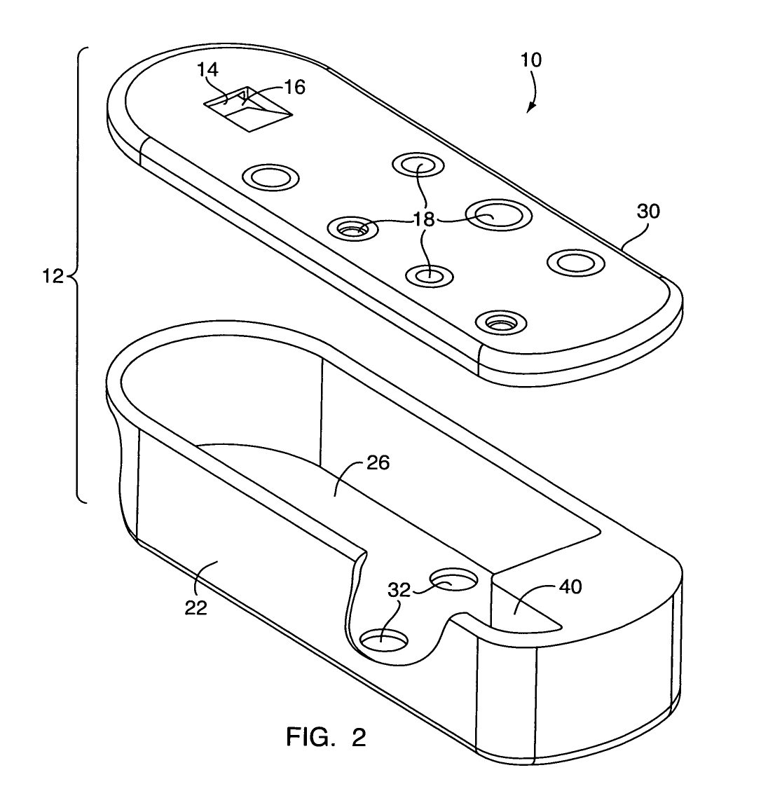

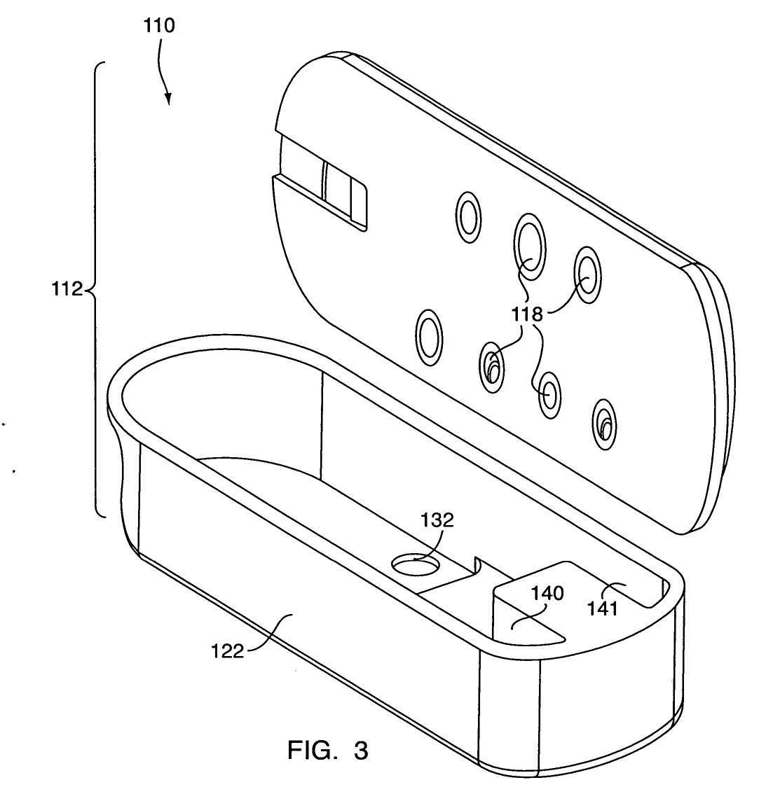

In any embodiment of the ocarina, the windway 14 is configured to direct an air stream across the fipple window onto a fipple edge 48 that is defined by the juncture of upper and lower surfaces of a ramp 46, as is shown in FIG. 4. The windway 14 is positioned relative to the rows of toneholes 18 such that an ocarina player may direct the air stream (e.g., by blowing) into the windway 14 while selectively covering and uncovering the toneholes with their fingers. The windway 14 includes a nozzle section 50 as well as a throat section 52 through which the flow of the air stream may be directed at the fipple edge 48 and into the sound chamber, which is shown at 28. The nozzle section 50 includes an upper surface 54 and a lower surface 56, at least one of which is inclined relative to the other to define a height h that progressively decreases toward the throat section 52. Additionally, the throat section 52 defines an upper surface 58 and a lower surface 60 that are substantially parallel to each other. The throat section 52 ensures that the air stream is properly aligned with the fipple edge 48 and reduces the turbulence of the air exiting the windway 14. The edges at the exit of the throat section 52 may be slightly radiused to further reduce the turbulence of the air exiting the windway 14. The upper surface 54 and lower surface 56 of the nozzle section 50, as well as the upper surface 58 and lower surface 60 of the throat section 52, are preferably accurately formed, shaped, and smoothed to provide the proper tone to the ocarina.

The fipple window 16 is cut, formed, or otherwise disposed in the body 12. The ramp 46 comprises an upper surface 62 and a lower surface 64, which are both oriented with respect to each other to define an acute angle 66 to define the fipple edge 48. The lower surface 64 lies in a plane that is slightly elevated above a ceiling of the sound chamber 28 defined by the inner surfaces of the cover 30 of the body 12 so as to define an offset cavity 68. The offset cavity 68 is positioned so as to align the fipple edge 48 with the center of the air stream exiting the throat section 52, thereby bifurcating the air stream.

After the air stream is propelled through the windway 14, the air stream impinges upon and is bisected by the fipple edge 48 creating a vacuum along the ramp 46 that continually shifts from the ramp's upper surface 62 to its lower surface 64.

This cycling of pressures at the fipple edge 48 causes the air in the sound chamber 28 to alternately become pressurized and depressurized with a certain frequency, thereby producing sound waves that pulse or oscillate at a corresponding frequency. Generally speaking, the speed at which air enters the sound chamber 28, the size and depth of the fipple window 16, the size and depth of any uncovered toneholes 18, and the total volume of air contained within the sound chamber 28 determine the frequency of pressurization/depressurization and, hence, the frequency of the sound waves emitted by the ocarina. (Selective covering and uncovering of toneholes 18 serves to vary the speed at which air can enter the sound chamber 28 during pressurization or exit the sound chamber 28 during depressurization, which varies the frequency of the sound waves emitted from the toneholes 18 and the fipple window 16.) Because the volume of air added by the recess 40 is significantly less than the total volume of air within the sound chamber 28, this invention allows an ocarina to be lengthened in order to move its toneholes 18 away from the fipple window 16 and to provide more room for toneholes 18 without the need to significantly reduce the depth of its main sound chamber 28.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of the appended claims.

What is claimed is:

1. An ocarina, comprising:
a sound chamber having a plurality of apertures that facilitate airflow communication through said sound chamber to produce a tone; and
a recess disposed at an inner surface of said sound chamber, at least one of said apertures being in register with said recess.

2. The ocarina of claim 1, wherein said sound chamber comprises at least one wall, a surface adjacent to and cooperative with said wall, and a cover adjacent to and cooperative with said wall.

3. The ocarina of claim 1, wherein said apertures comprise a windway, a fipple window, and at least one tonehole.

4. The ocarina of claim 3, wherein said tonehole is in register with said recess.

5. The ocarina of claim 1, wherein a width of said recess is less than a width of said sound chamber.

6. The ocarina of claim 1, wherein a depth of said recess is less than a depth of said sound chamber.

7. An ocarina, comprising:
a body comprising at least one wall, a surface positioned adjacent to and cooperative with said wall, and a cover positioned adjacent to and cooperative with said wall, wherein said wall, said surface, and said cover define a sound chamber, and wherein an inner surface of said wall includes a recess positioned adjacent to said cover; and
a plurality of apertures disposed within said body, at least one of said apertures being in register with said recess, and said apertures being configured to facilitate airflow through said body.

8. The ocarina of claim 7, wherein a width of said recess is less than a width of said sound chamber.

9. The ocarina of claim 7, wherein a depth of said recess is less than a depth of said sound chamber.

10. The ocarina of claim 7, wherein said aperture in register with said recess is a tonehole, said tonehole being selectively obstructable by a person playing said ocarina.

11. The ocarina of claim 7, further comprising a plurality of recesses in said inner surface of said wall.

12. The ocarina of claim 11, wherein each of said recesses has a tonehole in register therewith, said toneholes being selectively obstructable by a person playing said ocarina.

13. The ocarina of claim 7, wherein said apertures comprise a windway, a fipple window, and at least one tonehole.

14. The ocarina of claim 7, wherein said body is fabricated of wood, metal, clay, plastic, or a combination of the foregoing materials.
